(19) United States
(12) Patent Application Publication
(10) Pub. No.: US 2024/0004615 A1
(43) Pub. Date: Jan. 4, 2024

(54) CONVOLUTION OPERATION METHOD AND APPARATUS, MATRIX DECOMPRESSION DEVICE, AND GRAPHICS PROCESSOR

(71) Applicant: Glenfly Tech Co., Ltd., Shanghai (CN)

(72) Inventors: Zhongyu TAO, Shanghai (CN); Huaisheng ZHANG, Shanghai (CN); Renyu BIAN, Shanghai (CN)

(21) Appl. No.: 18/216,809

(22) Filed: Jun. 30, 2023

(30) Foreign Application Priority Data
Jul. 1, 2022 (CN) 202210769928.0

(51) Int. Cl. G06F 7/78; G06F 17/15

(52) U.S. Cl. CPC G06F 7/78; G06F 17/15

(57) ABSTRACT

Convolution operation method and apparatus, matrix decompression device and graphics processor are provided. The method includes: loading, from a preset memory layout, at least one target feature tile constituting any sub-feature map in an original feature map for the any sub-feature map; the memory layout being obtained by writing at least one feature tile into memory according to preset way of data arrangement; the at least one feature tile being obtained by tiling the original feature map; decompressing a feature map which is composed of the at least one target feature tile according to a convolution parameter of a convolutional layer to obtain a destination decompressed matrix; performing a matrix multiplication operation on the destination decompressed matrix and the decompressed matrix corresponding to a convolution kernel to obtain a convolution operation result of the original feature map. The present disclosure may improve the convolution operation efficiency.

This application claims priority under 35 U.S.C. § 119 to Chinese Patent Application No. 202210769928.0, filed on Jul. 1, 2022, the entire content of which is incorporated herein in its entirety.

### TECHNICAL FIELD

The present application relates to the technical field of general computer technology, and more particularly, relates to a convolution operation method, a convolution operation apparatus, a matrix decompression (MDC) device, a graphics processor, a storage medium and a computer program product.

### BACKGROUND

Convolution operation is an important step of a Convolutional Neural Network (CNN). The training and reasoning time of a Convolutional Neural Network (CNN) is often affected by the speed of a convolution operation.

In conventional technologies, the Convolutional Neural Network (CNN) usually performs a convolution by multiplying elements inside a convolution kernel filter with the corresponding elements in an input feature map, and then accumulating the results to obtain an element in an output feature map. The process then proceeds to a next step according to the size of a stride, and the above-mentioned operation is repeated until all elements from the output feature map are obtained. This leads to low convolution operation efficiency.

Therefore, there exists a problem of reduced convolution operation efficiency in conventional technologies.

### SUMMARY

In view of the defects existing in the prior art mentioned above, a convolution operation method, apparatus, computer device, computer readable storage medium and computer program product that may improve an efficiency of convolution operation are provided.

In a first aspect, a convolution operation method is provided by the present disclosure, the method includes the following:
loading at least one target feature tile, which constitutes any one of sub-feature maps in an original feature map, from a preset memory layout for the any one of the sub-feature maps; wherein the memory layout is obtained by writing at least one feature tile into a memory according to a preset way of data arrangement, and the at least one feature tile is obtained by tiling the original feature map;
decompressing a feature map which is composed of the at least one target feature tile according to a convolution parameter of a convolutional layer to obtain a destination decompressed matrix;
performing a matrix multiplication operation on the destination decompressed matrix and a decompressed matrix corresponding to a convolution kernel and obtaining a convolution operation result of the original feature map;

In accordance with an embodiment, after the step of reading an original feature map used for a convolution operation, the method further includes the following.
tiling the original feature map to obtain the at least one feature tile; and
according to the way of data arrangement, writing each feature tile sequentially into the memory in order to obtain the memory layout; wherein an arrangement dimension of the way of data arrangement comprises at least a batch processing dimension, a channel dimension and a position dimension of each feature tile in the original feature map.

In accordance with an embodiment, the according to the way of data arrangement, writing each feature tile sequentially into the memory in order to obtain the memory layout includes the following:
writing at least one feature tile of a same target position in the original feature map into the memory sequentially along a direction which corresponds to the channel dimension in order to obtain a feature tile brick corresponding to the target position.

In accordance with one of the embodiments, the tiling the original feature map to obtain the at least one feature tile includes the following:
obtaining a tile sample plate which is used to tile the original feature map;
determining a size of the tile sample plate in at least one direction;
performing zero padding on the original feature map to enable a size of the zero-padded feature map in a direction to be a multiple of a size of the tile sample plate in the direction; and
according to the tile sample plate, tiling the zero-padded feature map to obtain the at least one feature tile.

In accordance with an embodiment, there exist, in the memory layout, tile index coordinates corresponding to each feature tile; and; the loading at least one target feature tile, which constitutes any one of sub-feature maps in an original feature map, from a preset memory layout for the any one of the sub-feature maps includes the following:
obtaining decompressed matrix position coordinates corresponding to any one of the sub-feature maps; the decompressed matrix position coordinates being used to represent position information of the destination decompressed matrix in a decompressed matrix corresponding to the original feature map;
mapping the decompressed matrix position coordinates to target tile index coordinates; the target tile index coordinates being tile index coordinates, in the memory layout, corresponding to at least one target feature tile which constitutes any one of the sub-feature maps; and
loading a feature tile corresponding to the target tile index coordinates in the memory layout to obtain a target feature tile.

In accordance with an embodiment, the decompressing the feature map which is composed of the at least one target feature tile according to the convolution parameter of the convolutional layer to obtain the destination decompressed matrix includes the following:
decompressing the feature map, which is composed of the at least one target feature tile, according to a convolution parameter of a convolutional layer to obtain a decompressed matrix;
performing a transpose operation on the decompressed matrix to obtain the destination decompressed matrix.

In accordance with an embodiment, prior to the step of decompressing, the feature map which is composed of the at least one target feature tile according to a convolution parameter of a convolutional layer to obtain a destination decompressed matrix, the method further includes the following.
obtaining a convolutional layer to which a current convolution operation belongs.
parsing a convolution pattern of the convolutional layer to determine a convolution parameter of the convolutional layer.

In a second aspect, a convolution operation apparatus is further provided by the present disclosure. The apparatus includes the following:
a reading module, which is configured to read an original feature map used for a convolution operation′
a loading module, which is configured to load at least one target feature tile which constitutes any one of sub-feature maps from a preset memory layout for the any one of the sub-feature maps in an original feature map; the at least one feature tile is obtained by tiling the original feature map; a way of memory layout includes at least a batch processing dimension, a channel dimension and a position dimension of each feature tile in the original feature map;
a decompression module is configured to which is configured to decompress the feature map which is composed of the at least one target feature tile according to a convolution parameter of a convolutional layer to obtain a destination decompressed matrix; and;
an operation module, which is configured to perform a matrix multiplication operation on the destination decompressed matrix and a decompressed matrix corresponding to a convolution kernel to obtain a convolution operation result for the original feature map.

In a third aspect, a matrix decompression device is further provided by the present disclosure, which includes: a tile collector, a pattern parser, a matrix processing module and a matrix buffer.

The tile collector is configured to obtain at least one target feature tile, which constitutes any one of sub-feature maps in an original feature map, from a texture unit; the at least one target feature tile is loaded by the texture unit from a preset memory layout.

The pattern parser is configured to obtain a convolution parameter of a convolutional layer.

The matrix processing module is configured to perform a decompression processing on a feature map, which is composed of the at least one target feature tile, according to the convolution parameter to obtain a destination decompressed matrix; and

The matrix buffer is configured to cache the destination decompressed matrix based on which an execute unit is able to generate a convolution operation result of the original feature map.

In accordance with one of the embodiments, the matrix processing module comprises a matrix decompression engine and a matrix transpose control.

the matrix decompression engine is configured to decompress the feature map, which is composed of at least one target feature tile, according to the convolution parameter to obtain a decompressed matrix.

The matrix transpose control is configured to perform a transpose operation on the decompressed matrix to obtain the destination decompressed matrix.

In accordance with an embodiment, the convolution parameter comprises a convolution stride and a convolution kernel size; the matrix decompression engine is configured to convert, according to the convolution step size and the convolution kernel size, a feature map which is composed of the at least one feature tile into at least one row vector based on a position in the original map in sequence, and to splice the at least one row vector into a feature map matrix to obtain the decompressed matrix.

In accordance with an embodiment, the pattern parser is configured to: obtain a current convolutional layer to which a convolution operation belongs; and parse a convolution pattern of the current convolutional layer and determine a convolution parameter of the convolutional layer.

In accordance with an embodiment, the matrix buffer is further configured to transmit the destination decompressed matrix to a high-speed shared memory of the execute unit.

In a fourth aspect, a graphics processor is further provided by the present disclosure, which includes: a texture unit, an execute unit and a matrix decompression device.

The texture unit is configured to load at least one target feature tile which constitutes any one of sub-feature maps from a preset memory layout for any one of the sub-feature maps in an original feature map; the texture unit is further configured to transmit at least one target feature tile to the matrix decompression device.

The execute unit is configured to receive the destination decompressed matrix transmitted from the matrix decompression device, and to perform a matrix multiplication operation on the destination decompressed matrix and the decompressed matrix corresponding to a convolution kernel to obtain a convolution operation result of the original feature map.

In accordance with an embodiment, the execute unit is configured to send decompressed matrix position coordinates to the texture unit; the decompressed matrix position coordinates are used to represent a position information of the destination decompressed matrix in the decompressed matrix corresponding to the original feature map.

The texture unit is configured to map the decompressed matrix position coordinates to target tile index coordinates; the target tile index coordinates are tile index coordinates corresponding to at least one target feature tile which constitutes any one of the sub-feature maps in the memory layout; and to load the feature tiles corresponding to the target tile index coordinates in the memory layout to obtain the target feature tiles.

In accordance with an embodiment, the graphics processor is configured to tile the original feature map to obtain the at least one feature tile; according to the way of data arrangement, the graphics processor writes each feature tile to the memory in order to obtain the memory layout; where the way of data arrangement includes at least a batch processing dimension, a channel dimension and a position dimension of the feature tile in the original feature map.

In accordance with an embodiment, the graphics processor is configured to write at least one feature tile of a same target position in the original feature map into the memory sequentially along a direction which corresponds to the channel dimension in order to obtain a feature tile brick corresponding to the target position.

In accordance with an embodiment, the graphics processor is configured to obtain a tile sample plate which is used to tile the original feature map; the graphics processor is configured to perform zero padding on the original feature map so that a size of the zero-padded feature map in a direction is a multiple of a size of the tile sample plate in the direction; the graphics processor is configured to tile the zero-padded feature map to obtain the at least one feature tile according to the tile sample plate.

The above-mentioned convolution operation method, apparatus, Matrix decompression device, graphics processor, storage medium and computer program product loads at least one target feature tile, which constitutes any one of the sub-feature maps, from a preset memory layout for any one of the sub-feature maps in the original feature map, where the memory layout is obtained by writing at least one feature tile into a memory according to a preset way of data arrangement. at least one feature tile is obtained by tiling the original feature map; and according to the convolution parameters of the convolutional layer, a feature map, which is composed of at least one target feature tile, is decompressed to obtain the destination decompressed matrix, and a matrix multiplication operation is performed on the destination decompressed matrix and an decompressed matrix corresponding to a convolution kernel to obtain a convolution operation result of the original feature map; in this way, fast and accurate batch matrix multiplication operations on each sub-feature map in the original feature map may be performed to obtain the convolution operation result of the original feature map, and a simultaneous execution of matrix decompressed and matrix multiplication in the same operation kernel may be achieved, with no need to wait for the decompressed of the original feature map into a super large matrix in order to perform a matrix multiplication between the super large matrix and the decompressed matrix corresponding to the convolution kernel, which greatly improves an efficiency of convolution operation and an efficiency of operation execution; at the same time, since there is no need to store the super large matrix corresponding to the to the original feature map, a storage space of the matrix is also greatly reduced.

### BRIEF DESCRIPTION OF THE DRAWINGS

FIG. 1 is a schematic flow chart of a convolution operation method according to an embodiment;

FIG. 2a is a schematic diagram of a memory layout according to an embodiment;

FIG. 2b is a schematic diagram of a way of data arrangement according to an embodiment;

FIG. 3 is a schematic diagram of a decompressed matrix corresponding to an original feature map according to an embodiment;

FIG. 4 is a structural block diagram of a graphics processor according to an embodiment;

FIG. 5 is a schematic flow chart of a coordinate calculation process according to an embodiment.

FIG. 6 is a schematic flow chart of an extraction process according to an embodiment;

FIG. 7 is a schematic flow chart of a reading process according to an embodiment;

FIG. 8 is a structural block diagram of a brick controller according to an embodiment.

FIG. 9 is a structural block diagram of a brick cache according to an embodiment;

FIG. 10 is a structural block diagram of a matrix decompression device according to an embodiment;

FIG. 11 is a schematic diagram of a matrix decompression process according to an embodiment;

FIG. 12 is a schematic diagram of a transposition operation process according to an embodiment;

FIG. 13 is a schematic flow chart of a matrix writing process according to an embodiment;

FIG. 14 is a schematic diagram of a target feature tile loading process according to an embodiment;

FIG. 15 is a schematic flow chart of a convolution operation method according to another embodiment; and

FIG. 16 is a structural block diagram of a convolution operation apparatus according to an embodiment.

### DETAILED DESCRIPTION OF THE EMBODIMENTS

In order to make the objectives, technical solutions and advantages of the present disclosure clearer, the present disclosure is described in further detail below with reference to the accompanying drawings and embodiments. It should be understood that particular embodiments described herein are intended only to interpret the present disclosure and not intended to limit the present disclosure.

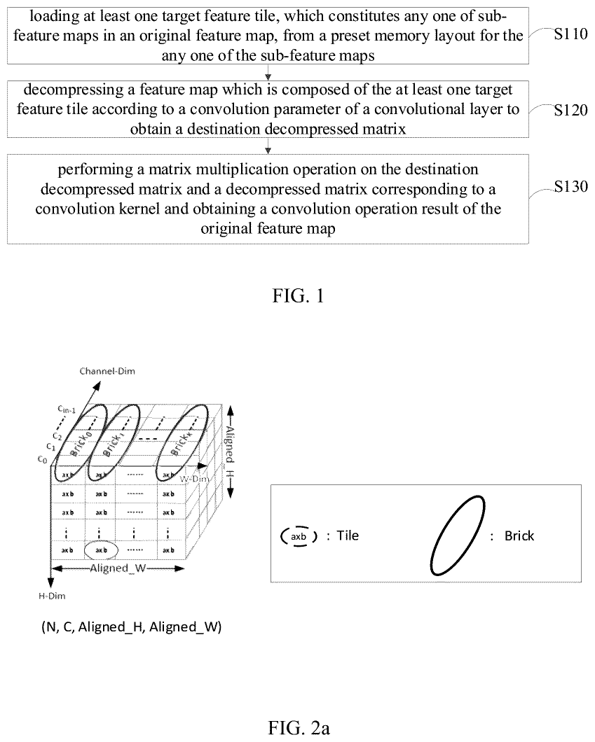

In an embodiment, as shown in FIG. 1, a convolution operation method is provided, and the method includes steps as follows.

Step S110, for any one of sub-feature maps in an original feature map, at least one target feature tile which constitutes the any one of the sub-feature maps is loaded from a preset memory layout.

The original feature map may be referred to as a feature map that needs to be subjected to a convolution operation using a convolution kernel.

A memory layout is obtained by writing at least one feature tile into a memory according to a preset way of data arrangement.

At least one feature tile is obtained by tiling the original feature map.

In a practical application, the original feature map may be tiled to obtain multiple feature tiles that constitute the original feature map. Then, the multiple feature tiles that constitute the original feature map are written into the memory according to a preset way of memory layout (a way of data arrangement) to form a memory layout for the original feature map. Each feature tile has corresponding coordinates in the memory layout of the original feature map.

In a specific implementation, when a convolution operation on the original feature map is performed by a graphics processor, at least one target feature tile, which constitutes any one of sub-feature maps in the original feature map, may be loaded for the any one of the sub-feature maps by a texture unit of the graphics processor from a preset memory layout.

Specifically, the texture unit of the graphics processor may obtain position information, in the original feature map, of any one of the sub-feature maps, and may map the position information into corresponding tile coordinate information. The tile coordinate information may include coordinates in a memory layout of at least one feature tile that constitutes any one of the sub-feature maps. Then, the graphics processor may load at least one target feature tile that constitutes any one of the sub-feature maps in the memory layout according to the tile coordinate information. Then, the texture unit of the graphics processor sends the at least one target feature tile to a matrix decompression device of the graphics processor.

In Step S120, according to a convolution parameter of a convolutional layer, a feature map, which is constituted by at least one target feature tile, is decompressed to obtain a destination decompressed matrix.

In a specific implementation, after the graphics processor loads at least one target feature tile that constitutes any one of the sub-feature maps, the graphics processor may obtain a convolution parameter (such as a size of a convolution kernel) of a convolutional layer, and may use an img2col (convert from feature map to matrix) algorithm to decompress the feature map, which is constituted by at least one target feature tile, to obtain the destination decompressed matrix.

Specifically, after the matrix decompression device of the graphics processor receives target feature tiles sent by the texture unit, the matrix decompression device of the graphics processor may use the img2col algorithm to decompress a feature map which is constituted by the target feature tiles to obtain an initial decompressed matrix; then, the graphics processor transposes the initial decompressed matrix to obtain a destination decompressed matrix. The matrix decompression device of the graphics processor sends the destination decompressed matrix to a high-speed buffer in an execution unit of the graphics processor for subsequent matrix multiplication.

Step S130, performing a matrix multiplication operation on the destination decompressed matrix and a decompressed matrix corresponding to a convolution kernel and obtaining a convolution operation result of the original feature map.

In a specific implementation, the execution unit of the graphics processor obtains the destination decompressed matrix, and an arithmetic operation unit (ALU) in the execution unit of the graphics processor performs a matrix multiplication operation on the destination decompressed matrix and the decompressed matrix corresponding to the convolution kernel to obtain a matrix multiplication result; then, the graphics processor uses a col2img algorithm (the inverse operation of the img2col algorithm) to convert the matrix multiplication result into an output feature map, which is used as a convolution operation result for the original feature map.

For any one of the sub-feature maps in the original feature map, technical solution of the current embodiment loads at least one target feature tile, which constitutes any one of the sub-feature maps, from a preset memory layout; where, the memory layout is obtained by writing at least one feature tile to the memory according to a preset way of data arrangement; at least one feature tile is obtained by tiling the original feature map; and according to the convolution parameters of the convolutional layer, a feature map, which is composed of at least one target feature tile, is decompressed to obtain the destination decompressed matrix, and a matrix multiplication operation is performed on the destination decompressed matrix and an decompressed matrix corresponding to a convolution kernel to obtain a convolution operation result of the original feature map. In this way, fast and accurate matrix multiplication operations may be performed in batch on respective sub-feature maps in the original feature map to obtain the convolution operation result of the original feature map; a simultaneous execution of matrix decompression and matrix multiplication in the same operation kernel may be achieved, there is no need to first decompress the original feature map into a super large matrix and then perform a matrix multiplication between the super large matrix and the decompressed matrix corresponding to the convolution kernel, thereby greatly improving an efficiency of convolution operation and an efficiency of operation execution; at the same time, since there is no need to store the super large matrix corresponding to the original feature map, a storage space of the matrix is also greatly reduced.

In another embodiment, the method further includes: tiling an original feature map to obtain at least one feature tile; according to a way of data arrangement, writing each feature tile sequentially into a memory to obtain a memory layout; where an arrangement dimension of the way of data arrangement includes at least a batch processing dimension, a channel dimension and a position dimension of each feature tile in the original feature map.

At least one feature tile of a same target position in the original feature map is written into the memory sequentially along a direction which corresponds to the channel dimension in order to obtain a feature tile brick corresponding to the target position.

In a specific implementation, the graphics processor may tile the original feature map to obtain at least one feature tile; then, the graphics processor may sequentially write each tile into the memory according to the batch processing dimension, the channel dimension, and the position dimension of each feature tile in the original feature map and obtain a memory layout. The graphics processor may sequentially write at least two feature tiles, which are at the same target position in the original feature map and possess different channels, into the memory along the direction corresponding to the channel dimension, in order to obtain a feature tile brick corresponding to the target position. In a practical application, the feature tile brick may also be named as a tile brick, or a brick, etc.

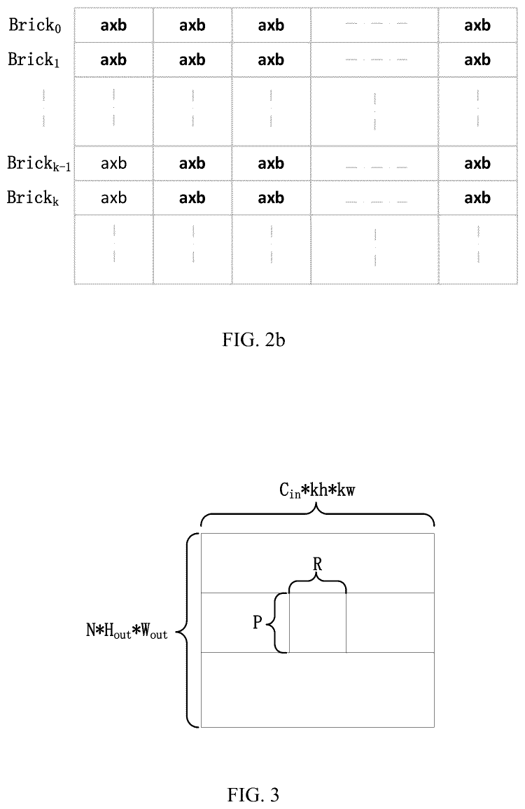

In a practical application, the above-mentioned way of data arrangement may be referred to as 4D-Brick. The graphics processor first divides an input original feature map into tiles according to a tile size of a×b, and at the same time, correspondingly aligns a size of a first direction Height of the original feature map according to the tile size and a size of a second direction Width of the original feature map according to the tile size, and then feature tiles obtained by tiling are stored along a channel direction, and stores tiles which are at the same position and at all channels together as one brick. For ease of understanding by those skilled in the art, please refer to FIG. 2a. FIG. 2a exemplarily shows a 4D-Brick memory layout when a batch size is 1; where the original feature map of each channel includes a×b feature tiles; the feature tiles at the same target position and different channels in the original feature map forms a feature tile brick.

For ease of understanding by those skilled in the art, an example of a schematic diagram of a way of data arrangement is also exemplarily provided by FIG. 2b. Please refer to FIG. 2b, an order to store feature data of the 4D-Brick may be as follows: storing tiles of all channels of Brick0 according to CHaWb, namely Brick0·C₀[a·b], Brick0·C₁ [a·b], . . . , Brick0·Cᵢₙ₋₁[a·b], then moving to a next tile along W-Dim until all bricks of W-Dim are stored, and finally moving along H-Dim until all bricks of a current batch (C, Aligned_H, Aligned_W) are stored.

If a batch size is N>1, then repeat above steps until all batches are stored, and all bricks in FIG. 2(a) are stored.

In technical solution of the embodiment, the original feature map is tiled, each tiled feature tile is written into the memory in sequence according to the way of data arrangement, in order to obtain the memory layout. Arrangement dimensions in the way of data arrangement, which is adopted by the technical solution, include at least a batch dimension, a channel dimension and a position dimension of feature tiles in the original feature map. In this way, the original feature map may be stored in the form of a four-dimensional channel block, which is convenient for rapidly loading the feature tiles that are used to construct the sub-feature map subsequently.

In another embodiment, tiling the original feature map to obtain at least one feature tile includes the following: obtaining a tile sample plate which is used to tile the original feature map; determining a size of the tile sample plate in at least one direction; performing zero padding on the original feature map so that a size of the zero-padded feature map in a direction is a multiple of a size of the tile sample plate in the direction; according to the tile sample plate, tiling the zero-padded feature map to obtain at least one feature tile.

In a specific implementation, during the process in which the graphics processor performs tiling on the original feature map to obtain at least one feature tile, the graphics processor may obtain a tile sample plate which is used to tile the original feature map, and may determine a size of the tile sample plate in at least one direction. Then, the graphics processor may determine whether the size of the original feature map in at least one direction is a multiple of the size of the tile sample template in this direction; if not, the graphics processor performs matrix zero padding on the original feature map, so that the size of the zero-padded feature map in the direction is a multiple of the size of the tile sample plate in the direction. Finally, the graphics processor uses the tile sample plate to tile the zero-padded feature map to obtain at least one feature tile.

For example, assuming that the dimensions of the original feature map are 40×37, and dimensions of the tile sample plate are 4×4: that is, a size of the original feature map in the x direction is 40, and a size of the original feature map in the y direction is 37; a size of the tile sample plate in the x direction is 4, and a size of the tile sample plate in the y direction is 4. It can be seen that the size of the original feature map in the x direction is a multiple of the size of the tile sample plate in the x direction, but the size of the original feature map in the y direction is not a multiple of the size of the tile template in the y direction. Therefore, a matrix zero padding is performed on the original feature map, and dimensions of the zero-padded feature map are 40×40. It can be seen that the size of the zero-padded feature map in the x direction is a multiple of the size of the tile template in the x direction, and the size of the zero-padded feature map in the y direction is a multiple of the size of the tile sample plate in the y direction.

In this way, by performing matrix zero padding on the original feature map, the size of the zero-padded feature map in a direction is set to be a multiple of the size of the tile sample plate in the direction, so that the tile sample plate may be successfully adopted to tile the zero-padded feature map into an integer number of feature tiles.

In another embodiment, loading at least one target feature tile, which constitutes any one of the sub-feature maps in the original feature map, from a preset memory layout for the any one of the sub-feature maps includes the following: obtaining decompressed matrix position coordinates corresponding to any one of the sub-feature maps; mapping the decompressed matrix position coordinates to target tile index coordinates; loading a feature tile corresponding to the target tile index coordinates in the memory layout to obtain a target feature tile.

The decompressed matrix position coordinates are used to represent position information of the destination decompressed matrix in the decompressed matrix corresponding to the original feature map.

The target tile index coordinates are tile index coordinates, in the memory layout, corresponding to at least one target feature tile which constitutes any one of the sub-feature maps.

There exist tile index coordinates corresponding to each feature tile in the memory layout.

In a specific implementation, when the graphics processor loads, from the preset memory layout, at least one target feature tile which is used to constitute any one of the sub-feature maps, the graphics processor may obtain the decompressed matrix position coordinates corresponding to any one of the sub-feature maps. Then, the decompressed matrix position coordinates are mapped to target tile index coordinates. Finally, the graphics processor loads a feature tile corresponding to the target tile index coordinates in the memory layout to obtain a target feature tile.

In technical solution of the embodiment, decompressed matrix position coordinates are mapped to the target tile index coordinates by obtaining the decompressed matrix position coordinates corresponding to any one of the sub-feature maps, that is, the position coordinates of the required decompressed matrix in the original feature map, and the feature tiles are loaded corresponding to the target tile index coordinates in the memory layout, so that the target feature tiles that constitute any one of the sub-feature maps may be accurately loaded in the memory layout.

In another embodiment, according to a convolution parameter of a convolutional layer, decompressing a feature map, which is composed of at least one target feature tile, to obtain a destination decompressed matrix, includes the following: according to a convolution parameter of a convolutional layer, decompressing the feature map, which is composed of at least one target feature tile, to obtain a destination decompressed matrix; performing a transpose operation on the decompressed matrix to obtain the destination decompressed matrix.

In a specific implementation, when the graphics processor decompresses a feature map composed of at least one target feature tile according to a convolution parameter of a convolutional layer, to obtain a destination decompressed matrix, the graphics processor may decompress, according to the convolution parameter of the convolutional layer, the feature map composed of at least one target feature tile to obtain a decompressed matrix; finally, the graphics processor performs a transpose operation on the decompressed matrix to obtain a destination decompressed matrix.

In technical solution of the embodiment, the feature map, which is composed of at least one target feature tile, is decompressed according to a convolution parameter of a convolutional layer, and after the decompressed matrix is obtained, the decompressed matrix is transposed so that the obtained destination decompressed matrix may be in a matrix form required by a subsequent matrix multiplication operation.

In another embodiment, the method further includes: obtaining a convolutional layer to which a current convolution operation belongs; parsing a convolution pattern of the convolutional layer to determine a convolution parameter of the convolutional layer.

The convolution parameter includes a size of a convolution kernel filter, a stride, and a pad.

In a specific implementation, the graphics processor may obtain a convolutional layer to which a current convolution operation belongs; then, the graphics processor parses a convolution pattern of the convolutional layer to determine a convolution parameter of the convolutional layer. Specifically, the graphics processor only needs to parse the convolution pattern of one convolutional layer once, and the same convolution pattern is applied to data of remaining feature tiles of such convolutional layer.

In technical solution of the embodiment, by obtaining a convolutional layer to which a current convolution operation belongs, and parsing a convolution pattern of a convolutional layer, a convolution parameter of the convolutional layer corresponding to target feature tiles in the same convolutional layer is accurately determined, and the feature map which is constituted by the above-mentioned target feature tiles is decompressed based on the convolution parameter.

For ease of understanding by those skilled in the art, a schematic diagram of a decompressed matrix corresponding to the original feature map is provided by FIG. 3. Reference may be made to FIG. 3, matrix A is a complete matrix decompressed by img2col, and [P,R] is a sub-matrix of A, which may be mapped to 4D-Brick through the coordinates (X, Y) of the upper left corner of the sub-matrix, and the texture unit (TU) loads tiles in a brick into a matrix decompression (MDC) device for img2col decompressed through a mapping address. In FIG. 3, P and R can be configured according to a required target matrix size.

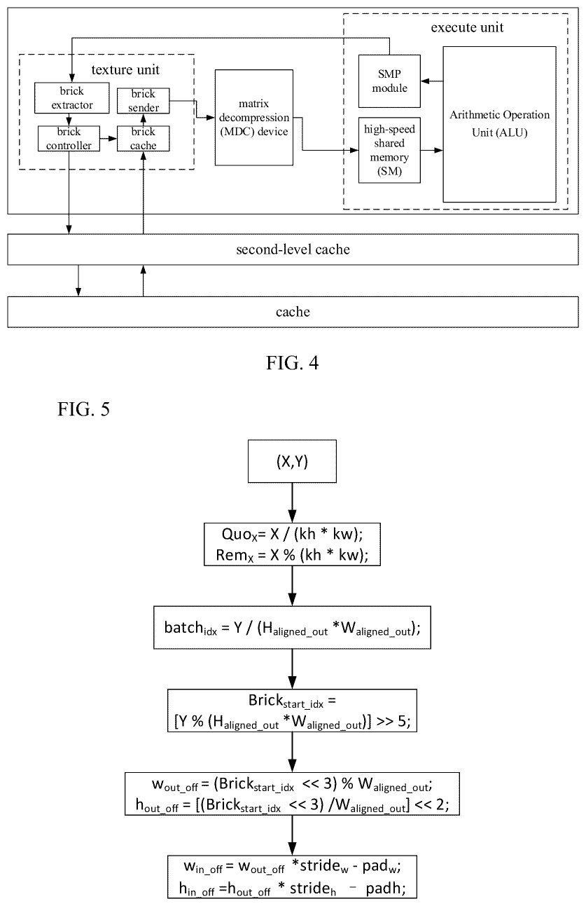

As shown in FIG. 4, a graphics processor, which includes a texture unit, a matrix decompression (MDC) device and an execute unit, is provided thereof.

The texture unit may include a brick extractor, a brick controller, a brick cache and a brick sender; where the brick controller includes a tile loader.

The execute unit includes a sampling (SMP) module, an arithmetic logic unit (ALU) and a high-speed shared memory (SM).

In a specific implementation, parameters including a tile size a×b=4×8, and P=R=32 are taken as an example for an illustration as follows. During the process in which the graphics processor maps decompressed matrix position coordinates to target tile index coordinates, the graphics processor obtains decompressed matrix position coordinates corresponding to any one of the sub-feature maps, that is, coordinates (X, Y)∈[C_{IN}*kh*kw, N*Hₒᵤₜ*Wₒᵤₜ] of upper left corner of any given [P, R]; the execute unit of the graphics processor calculates coordinates (Quoₓ, Remₓ, batch_{idx}, h_{in_off}, w_{in_off}), and sends them to a brick extractor in the texture unit through the SMP module. A specific calculation process of the coordinates is shown in FIG. 5: where (strideₕ, stride_{w}) and (padₕ,pad_{w}) are invariable constants for a same convolutional layer in CNN. For different convolutional layers, (strideₕ, stride_{w}) and (padₕ, pad_{w}) may vary.

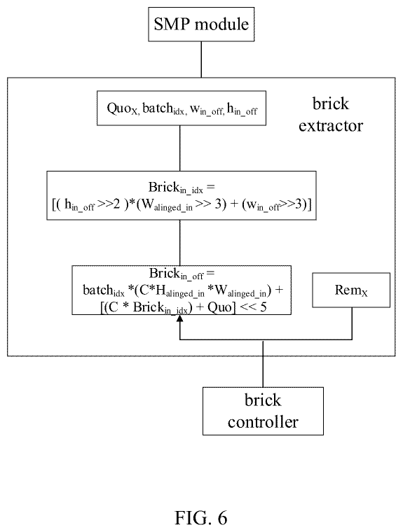

After the brick extractor receives the coordinates (Quoₓ, Remₓ, batch_{idx}, h_{in_off}, w_{in_off}) the brick extractor extracts the above coordinate information to obtain Brick_{in_off} and Rem_{X}, and sends the extracted information to the brick controller. An extraction process is shown in FIG. 6.

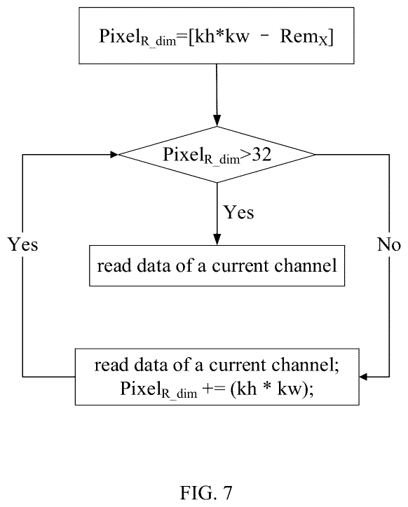

Reference may be made to FIG. 7. When the tile loader loads tile data, it first searches in the brick cache to find the data. If target tile data is in the brick cache, then corresponding data is directly sent to the brick sender from the brick cache. If not, the tile loader requests the data from a second-level cache L2.

Specifically, after receiving information from the brick extractor, the brick controller calculates a tile data of a brick that needs to be loaded through the Tile Loader of the brick controller according to RemX; where a flow loading the tile data in the brick by the tile loader is shown in FIG. 8, so that the length in the R direction of [P,R] is 32. For the P direction, since the output feature map is also divided according to tile a×b, a value of P in the present embodiment is P=a×b=4×8=32 after img2col decompression.

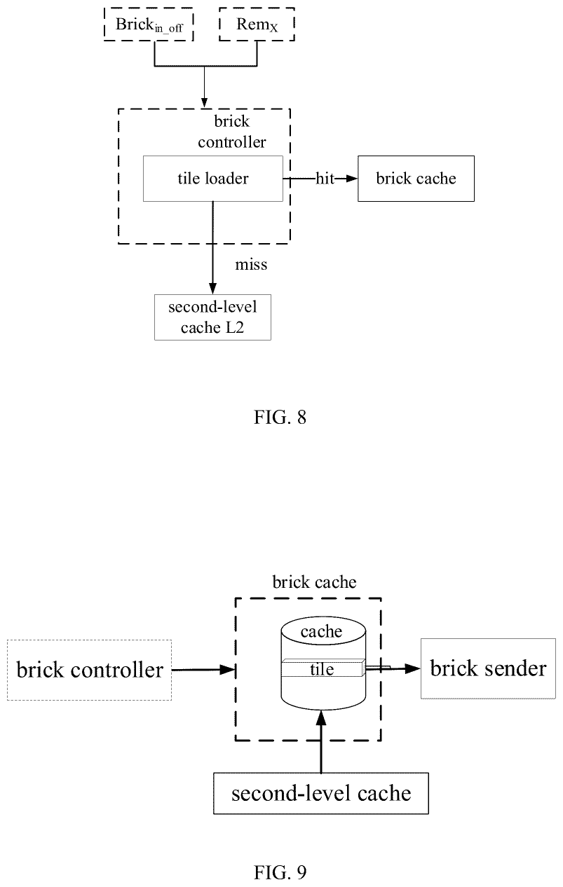

Reference may be made to FIG. 9. According to tile data requested by the brick controller, the brick cache directly sends the tile data to the brick sender if the tile data is in the cache. If the tile data is not in the cache, tiles in a brick which is returned by the second-level cache L2 are stored in the cache, and the tile data (that is, target feature tiles) is sent to the brick sender.

The brick sender is responsible for sending the target feature tiles to the Matrix decompression (MDC) device. Specifically, the texture unit may, based on (strideₕ, stride_{w}) and (padₕ, pad_{w}) of a current convolutional layer, and combined with Brickin_off in the brick controller, load the corresponding target feature tiles from the 4D-Brick memory layout. These tiles are then sent to the matrix decompression device via the brick sender, allowing the matrix decompression device to dynamically perform img2col on the received tiles and decompress them into a matrix of size [P, Q], which is a [32, 32] matrix in this implementation example. It should be noted that if the texture unit encounters an Out-of-Bound (OOB) situation during loading, a corresponding part of a returned tile may be filled with zeros.

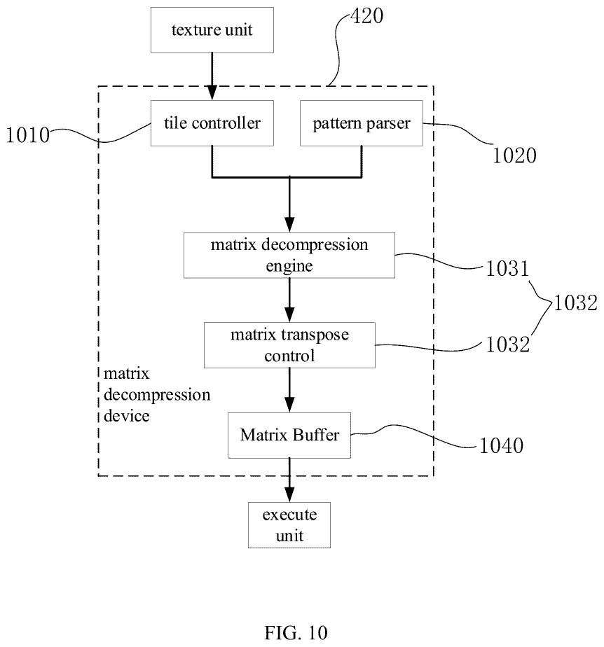

In another embodiment, as shown in FIG. 10, a matrix decompression (MDC) device 420 is provided thereof, including: a tile collector 1010, a pattern parser 1020, a matrix processing module 1030 and a matrix buffer 1040, where the matrix processing module includes a matrix decompression engine 1031 and a matrix transpose control 1032.

In a specific implementation, the tile collector is configured to obtain at least one target feature tile, which constitutes any one of the sub-feature maps in the original feature map, from the brick sender of the texture unit. The target feature tile is loaded by the texture unit from the preset memory layout. Specifically, the tile collector may receive a data of a tile (a target feature tile) corresponding to an output feature map with a size of a given tile a×b.

A size of a corresponding input feature map that needs to be collected by the tile collector may be calculated by a following formula.

$$\begin{matrix}{h}_{input} = ( {h}_{output} - 1 ) * {stride}_{h} - ( 2 * {pad}_{h} - kh ) \\ = {( a - 1 )}^{*} {stride}_{h} - ( 2 * {pad}_{h} - kh )\end{matrix}$$

$$\begin{matrix}{w}_{input} = ( {w}_{output} - 1 ) * {stride}_{w} - ( 2 * {pad}_{w} - kw ) \\ = ( b - 1 ) * {stride}_{w} - ( 2 * {pad}_{w} - kw )\end{matrix}$$

The tile collector collects all data of tiles with a size of (hᵢₙₚᵤₜ, wᵢₙₚᵤₜ), and the matrix decompression engine may perform img2col decompression on the feature map composed of the target feature tiles.

The pattern parser is configured to obtain convolution parameters of a convolutional layer; specifically, the matrix decompression engine is specifically configured to sequentially convert a feature map, which is composed of at least one feature tile, into at least one row vector based on a position of the original map, and to splice at least one row vector into a feature map matrix to obtain a decompressed matrix according to a convolution step size and a convolution kernel size.

In a practical application, the matrix decompression (MDC) device may support common convolution parameters in a CNN model, such as a convolution kernel filter (filter kh*kw) of the following sizes: 1×1, 3×3, 5×5, 7×7, 1×7, 7×1, 1×3, 3×1, etc., the stride may be 1 or 2, etc., and a padding height and a padding width may be of sizes: 0×0, 1×1, 2×2, 3×3, 0×3, 3×0, 0×1, 1×0, etc.

The matrix processing module is configured to perform a decompression processing on a feature map, which is composed of at least one target feature tile, according to the convolution parameters to obtain a destination decompressed matrix. The matrix decompression engine is configured to decompress the feature map, which is composed of at least one target feature tile, according to the convolution parameters to obtain a decompressed matrix; the matrix transpose control is configured to perform a transpose operation on the decompressed matrix to obtain a destination decompressed matrix.

After the tile collector collects all tile data and convolution parameters which are parsed by the Pattern Parser, then the matrix decompression engine may perform img2col decompression. The matrix decompression engine performs img2col decompression on an input tile data (hᵢₙₚᵤₜ, wᵢₙₚᵤₜ) according to the parsed convolution parameters. Specifically, according to a convolution step size and a convolution kernel size, the feature map which is composed of at least one target feature tile may be sequentially converted into at least one row vector according to a position of the original image, and at least one row vector may be spliced into a feature map matrix to obtain a decompressed matrix.

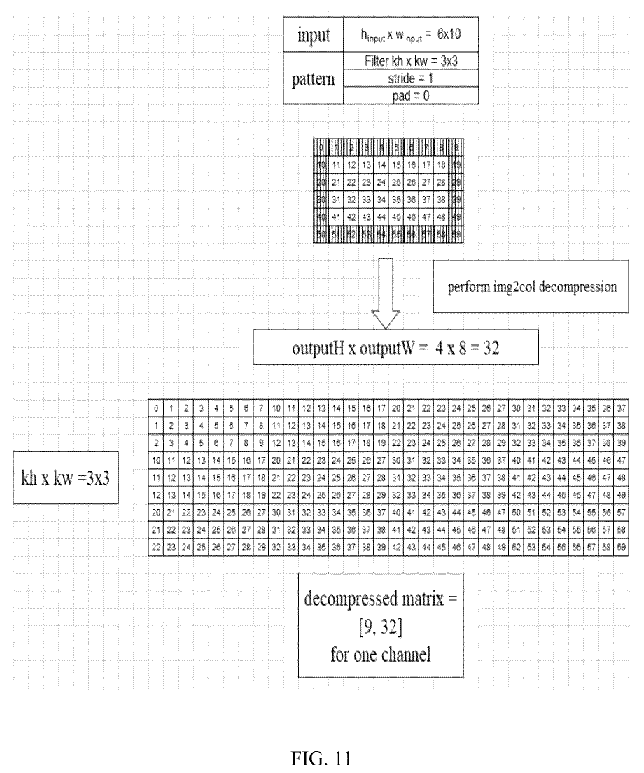

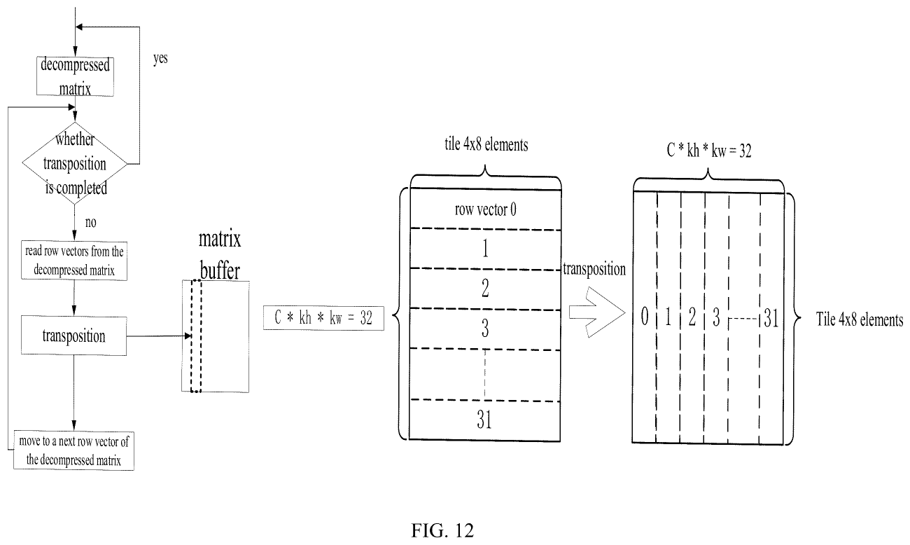

FIG. 11 uses a common example in which a convolution kernel filter of CNN is 3×3, a stride size is 1, and a padding is 0, to illustrate the process of img2col decompression by the matrix decompression engine. It should be noted that in FIG. 11, only one channel corresponding to the tile data is decompressed by img2col, which is decompressed into a [9,32] matrix. Rest convolution modes may be similarly derived, which will not be repeated herein.

For ease of understanding by those skilled in the art, a schematic diagram of a transposition operation process is provided by FIG. 12. Reference may be made to FIG. 12, after the matrix decompression engine performs img2col decompression to obtain a destination decompressed matrix, The matrix transpose control transposes the decompressed matrix to obtain a destination decompressed matrix, and writes the destination decompressed matrix to the matrix buffer.

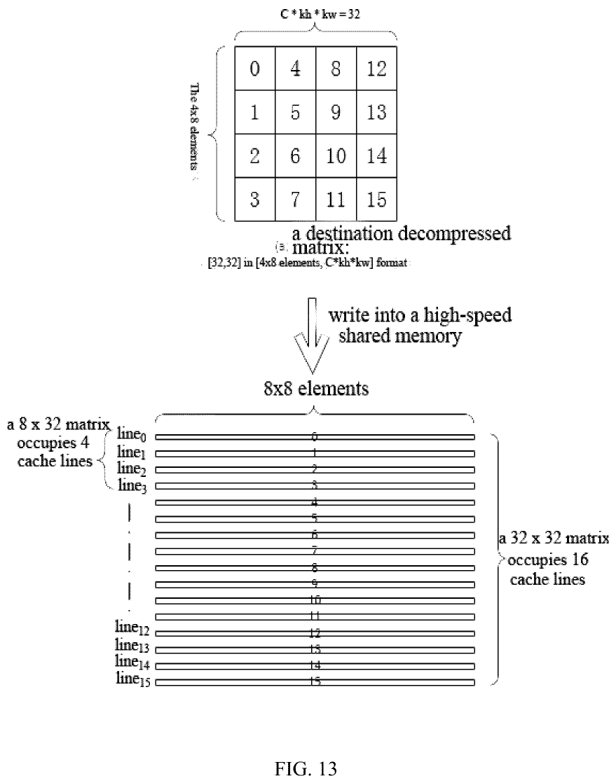

The matrix buffer is further configured to cache the destination decompressed matrix, and is further configured to transmit the destination decompressed matrix to the high-speed shared memory of the execute unit, so that the execute unit generates a convolution operation result of the original feature map according to the destination decompressed matrix. The Execute unit also writes the matrix to the high-speed shared memory according to a current data format. For the ease of understanding by those skilled in the art, reference may be made to FIG. 13. FIG. 13 uses an 8-bit data format as an example to illustrate the process in which MDC writes [P, R] (which is [32,32] as an example in the current embodiment) into the high-speed shared memory.

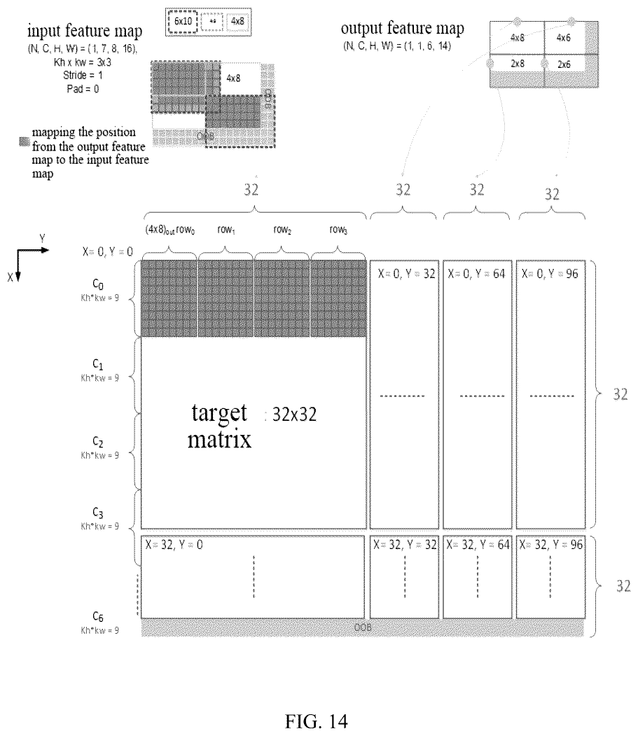

For ease of understanding by those skilled in the art, an example of loading target feature tiles is provided by the current embodiment; reference may be made to FIG. 14, which is an example of tile data of a brick loaded by the texture unit from the 4D-Brick memory layout and an example of an img2col decompression of the tile data by the MDC, where an example of the decompressed target matrix [P,Q] is [32,32]. In this example, a convolution operation is performed on an input feature map whose (N, C, Aligned_H, Aligned_W) is (1,7,8,16), where a convolution kernel filter is 3×3, a stride is 1, and a padding is 0. The output feature map is (1,1,6,14).

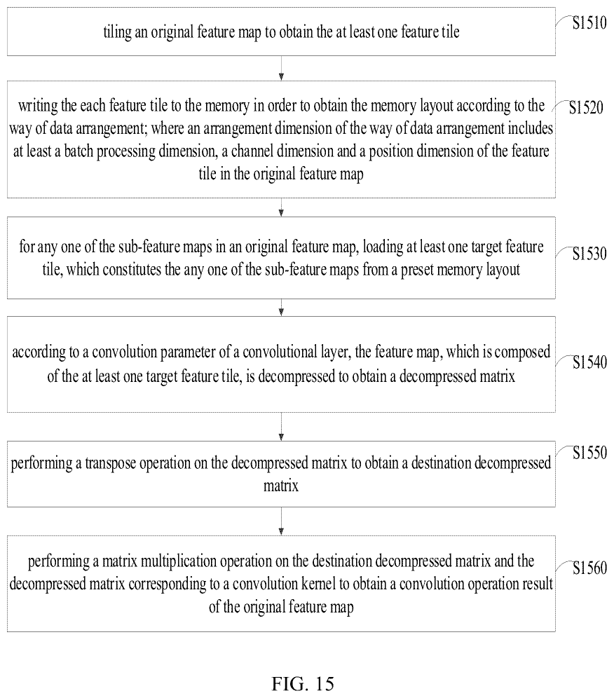

In another embodiment, as shown in FIG. 15, a convolution operation method is provided, which includes steps as follows.

Step S1510, tiling an original feature map to obtain the at least one feature tile.

Step S1520, writing the each feature tile to the memory in order to obtain the memory layout according to the way of data arrangement; where an arrangement dimension of the way of data arrangement includes at least a batch processing dimension, a channel dimension and a position dimension of the feature tile in the original feature map.

Step S1530, for any one of the sub-feature maps in an original feature map, loading at least one target feature tile, which constitutes the any one of the sub-feature maps from a preset memory layout.

Step S1540, according to a convolution parameter of a convolutional layer, the feature map, which is composed of the at least one target feature tile, is decompressed to obtain a decompressed matrix.

Step S1550, performing a transpose operation on the decompressed matrix to obtain a destination decompressed matrix.

Step S1560, performing a matrix multiplication operation on the destination decompressed matrix and the decompressed matrix corresponding to a convolution kernel to obtain a convolution operation result of the original feature map.

It should be noted that, references to the specific limitations of the above-mentioned steps may be made according to the specific limitations of the above-mentioned convolution operation method, hence is not to be repeated herein.

In another embodiment, a graphics processor is provided, which includes the following: a texture unit, an execute unit, and the above-mentioned matrix decompression device.

The texture unit is configured to load at least one target feature tile, which constitutes any one of the sub-feature maps, from a preset memory layout for any one of the sub-feature maps in the original feature map; and the Texture unit is further configured to transmit at least one target feature tile to the matrix decompression device.

The execute unit is configured to receive the destination decompressed matrix transmitted from the matrix decompression device, and to perform a matrix multiplication operation on the destination decompressed matrix and the decompressed matrix corresponding to a convolution kernel to obtain a convolution operation result of the original feature map.

In another embodiment, the execute unit is configured to send a decompressed matrix position coordinates to the texture unit; the decompressed matrix position coordinates are used to represent a position information of the destination decompressed matrix in the decompressed matrix corresponding to the original feature map.

The texture unit is configured to map a decompressed matrix position coordinates to a target tile index coordinates; the target tile index coordinates are tile index coordinates corresponding to at least one target feature tile which constitutes any one of the sub-feature maps in the memory layout; the texture unit loads the feature tiles corresponding to the target tile index coordinates in the memory layout to obtain the target feature tiles.

In another embodiment, the graphics processor is configured to perform tiling on the original feature map to obtain at least one feature tile; according to a way of data arrangement, the graphics processor writes each feature tile to a memory in order to obtain a memory layout; where the way of data arrangement includes at least a batch processing dimension, a channel dimension and a position dimension of the feature tile in the original feature map.

In another embodiment, the graphics processor is configured to write at least one feature tile of a same target position in the original feature map into the memory sequentially along a direction which corresponds to the channel dimension in order to obtain a feature tile block corresponding to the target position.

In another embodiment, the graphics processor is configured to obtain a tile sample plate which is used to tile the original feature map. The graphics processor is further configured to determine a size of the tile sample plate in at least one direction, and to perform zero padding on the original feature map so that a size of the zero-padded feature map in a direction is a multiple of a size of the tile sample plate in the direction; according to the tile sample plate, the zero-padded feature map is tiled to obtain at least one feature tile.

It is to be understood that, although steps in the flow charts involved in the above-mentioned embodiments are displayed in sequence based on indication of arrows, these steps are not necessarily executed sequentially based on the sequence indicated by the arrows. Unless otherwise explicitly specified herein, sequence to execute the steps is not strictly limited, and the steps may be executed in other sequences. In addition, at least some steps in in the flow charts involved in the above-mentioned embodiments may include multiple steps or multiple stages, and these steps or stages are not necessarily executed at the same moment, but may be executed at different moments. These steps or stages are not necessarily executed in sequence, but may be executed in turn or alternately with another step or at least a part of steps or stages of another step.

Based on a same inventive concept, an embodiment of the present disclosure further provides a convolution operation apparatus to implement the above-mentioned convolution operation method. The implementation solution to the problem provided by the apparatus is similar to the implementation solution described in the above-mentioned method. Therefore, references to the specific limitations of the above-mentioned steps may be made according to the specific limitations of the above-mentioned convolution operation method, hence is not to be repeated herein.

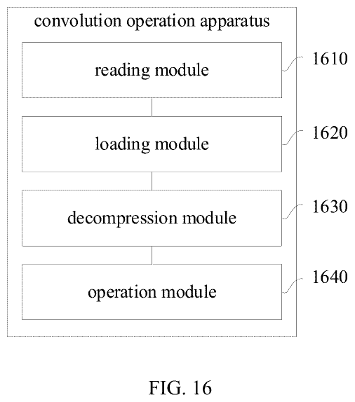

In an embodiment, as shown in FIG. 16, a convolution operation apparatus is provided, which includes the following.

A reading module 1610 is configured to read an original feature map used for a convolution operation.

A loading module 1620 is configured to load at least one target feature tile, which constitutes the any one of the sub-feature maps, from a preset memory layout for any one of the sub-feature maps in the original feature map; the memory layout is obtained by writing at least one feature tile into the memory according to a preset memory layout; the at least one feature tile is obtained by tiling the original feature map; a way of memory layout includes at least a batch processing dimension, a channel dimension and a position dimension of the feature tile in the original feature map.

A decompression module 1630 is configured to decompress the feature map which is composed of the at least one target feature tile according to a convolution parameter of a convolutional layer to obtain a destination decompressed matrix.

An operation module 1640 is configured to perform a matrix multiplication operation on the destination decompressed matrix and a decompressed matrix corresponding to a convolution kernel to obtain a convolution operation result for the original feature map.

In accordance with one of the embodiments, the apparatus is further configured to perform tiling on an original feature map to obtain at least one feature tile; according to the way of data arrangement, the apparatus writes the each feature tile to the memory in order to obtain the memory layout; where the way of data arrangement includes at least a batch processing dimension, a channel dimension and a position dimension of the feature tile in the original feature map.

In accordance with an embodiment, the apparatus is further configured to write at least one feature tile of a same target position in the original feature map into the memory sequentially along a direction which corresponds to the channel dimension in order to obtain a feature tile block corresponding to the target position.

In accordance with an embodiment, the apparatus is further configured to obtain a tile sample plate which is used to tile the original feature map. The apparatus is further configured to determine a size of the tile sample plate in at least one direction, and to perform zero padding on the original feature map so that a size of the zero-padded feature map in a direction is a multiple of a size of the tile sample plate in the direction; according to the tile sample plate, the zero-padded feature map is tiled to obtain at least one feature tile.

In accordance with an embodiment, there exists a tile index coordinates corresponding to each feature tile in the memory layout, and the loading module 1620 is specifically configured to obtains a decompressed matrix position coordinates corresponding to any one of the sub-feature maps; the decompressed matrix position coordinates are used to represent a position information of the destination decompressed matrix in the decompressed matrix corresponding to the original feature map; the decompressed matrix position coordinates are mapped to an target tile index coordinates; the target tile index coordinates are tile index coordinates corresponding to at least one target feature tile which constitutes any one of the sub-feature maps in the memory layout; the feature tiles corresponding to the target tile index coordinates are loaded in the memory layout to obtain the target feature tiles.

In accordance with an embodiment, the decompression module 1630 is specifically configured to decompress the feature map, which is composed of the at least one target feature tile, to obtain a decompressed matrix according to a convolution parameter of a convolutional layer; the decompression module is further configured to perform a transpose operation on the decompressed matrix to obtain a destination decompressed matrix.

In accordance with one of the embodiments, the apparatus is also used to obtain a current convolutional layer to which the convolution operation belongs; the apparatus is configured to parse a convolution mode of the current convolutional layer, and to determine a convolution parameter of the convolutional layer.

Each module in the above-mentioned convolution operation apparatus may be implemented in whole or in part by software, hardware, and a combination of hardware and software. The above-mentioned each module can be embedded in the form of hardware in a processor, or be independent from a processor in a computer device, or be stored in the form of software in a memory of a computer device, so as to make it easier for the processor to call and execute an operation corresponding to each module.

Those of ordinary skill in the art may understand that all or some of the above-mentioned embodiments may be implemented by a computer program instructing relevant hardware. The computer program may be stored in a nonvolatile computer readable storage medium. When the computer program is executed, the execution may include embodiments of the above-mentioned methods. Any references to a memory, a database, or another medium used in the various embodiments provided in the disclosure may include at least one of a non-volatile and a volatile memory. The nonvolatile Memory may include Read-Only Memory (ROM), magnetic tape, floppy disk, flash memory, optical memory, high-density embedded nonvolatile memory, Resistive Random Access Memory (ReRAM), Magnetic Random Access Memory (MRAM), Ferroelectric Random Access Memory (FRAM), Phase Change Memory (PCM), graphene memory, and the like. Volatile memory may include Random Access Memory (RAM), external cache memory, and the like. By way of illustration and not limitation, RAM may take many forms, such as Static Random Access Memory (SRAM) or Dynamic Random Access Memory (DRAM), among others. The databases referred in various embodiments provided herein may include at least one of relational and non-relational databases. The non-relational database may include, but is not limited to, a block chain based distributed database, and the like. The processors referred in the embodiments provided herein may be, but is not limited to, general purpose processors, central processing units, graphics processors, digital signal processors, programmable logic apparatus, quantum computing based data processing logic apparatus, and the like.

Technical features of the above-mentioned embodiments may be freely combined. To be brief in description, not all possible combinations of the technical features in the above-mentioned embodiments are described. However, the combinations of these technical features should be considered to fall within the scope of this specification as long as these combinations are not contradictory.

The above-mentioned embodiments only represent several embodiments of this disclosure, and their descriptions are specific and detailed, but should not be understood as limiting the scope of this disclosure. It should be noted that, several modifications and improvements can be made by those of ordinary skill in the art without departing from the concept of this disclosure, which belong to the protection scope of this disclosure. Therefore, it is intended that the protection scope of this disclosure shall be subjected to the appended claims.

What is claimed is:

1. A convolution operation method, comprising:
loading at least one target feature tile, which constitutes any one of sub-feature maps in an original feature map, from a preset memory layout for the any one of the sub-feature maps; wherein the memory layout is obtained by writing at least one feature tile into a memory according to a preset way of data arrangement, and the at least one feature tile is obtained by tiling the original feature map;
decompressing a feature map which is composed of the at least one target feature tile according to a convolution parameter of a convolutional layer to obtain a destination decompressed matrix; and
performing a matrix multiplication operation on the destination decompressed matrix and a decompressed matrix corresponding to a convolution kernel and obtaining a convolution operation result of the original feature map.

2. The convolution operation method of claim 1, further comprising:
tiling the original feature map to obtain the at least one feature tile; and
according to the way of data arrangement, writing each feature tile sequentially into the memory in order to obtain the memory layout; wherein an arrangement dimension of the way of data arrangement comprises at least a batch processing dimension, a channel dimension and a position dimension of each feature tile in the original feature map.

3. The convolution operation method of claim 2, wherein the according to the way of data arrangement, writing each feature tile sequentially into the memory in order to obtain the memory layout comprises:
writing at least one feature tile of a same target position in the original feature map into the memory sequentially along a direction which corresponds to the channel dimension in order to obtain a feature tile brick corresponding to the target position.

4. The convolution operation method of claim 2, wherein the tiling the original feature map to obtain the at least one feature tile comprises:
obtaining a tile sample plate which is used to tile the original feature map;
determining a size of the tile sample plate in at least one direction;
performing zero padding on the original feature map to enable a size of the zero-padded feature map in a direction to be a multiple of a size of the tile sample plate in the direction; and
according to the tile sample plate, tiling the zero-padded feature map to obtain the at least one feature tile.

5. The convolution operation method of claim 1, wherein there exist, in the memory layout, tile index coordinates corresponding to each feature tile; and
wherein the loading at least one target feature tile, which constitutes any one of sub-feature maps in an original feature map, from a preset memory layout for the any one of the sub-feature maps comprises:
obtaining decompressed matrix position coordinates corresponding to any one of the sub-feature maps; the decompressed matrix position coordinates being used to represent position information of the destination decompressed matrix in a decompressed matrix corresponding to the original feature map;
mapping the decompressed matrix position coordinates to target tile index coordinates; the target tile index coordinates being tile index coordinates, in the memory layout, corresponding to at least one target feature tile which constitutes any one of the sub-feature maps; and
loading a feature tile corresponding to the target tile index coordinates in the memory layout to obtain a target feature tile.

6. The convolution operation method of claim 1, wherein the decompressing the feature map which is composed of the at least one target feature tile according to the convolution parameter of the convolutional layer to obtain the destination decompressed matrix comprises:
decompressing the feature map, which is composed of the at least one target feature tile, according to a convolution parameter of a convolutional layer to obtain a decompressed matrix;
performing a transpose operation on the decompressed matrix to obtain the destination decompressed matrix.

7. The convolution operation method of claim 1, further comprising:
obtaining a convolutional layer to which a current convolution operation belongs;
parsing a convolution pattern of the convolutional layer to determine a convolution parameter of the convolutional layer.

8. A convolution operation apparatus, comprising:
a reading module, which is configured to read an original feature map used for a convolution operation;
a loading module, which is configured to load at least one target feature tile which constitutes any one of sub-feature maps from a preset memory layout for the any one of the sub-feature maps in an original feature map; wherein the memory layout is obtained by writing at least one feature tile into a memory according to a preset way of data arrangement, the at least one feature tile is obtained by tiling the original feature map; a way of memory layout includes at least a batch processing dimension, a channel dimension and a position dimension of each feature tile in the original feature map;
a decompression module, which is configured to decompress a feature map which is composed of the at least one target feature tile according to a convolution parameter of a convolutional layer to obtain a destination decompressed matrix; and
an operation module, which is configured to perform a matrix multiplication operation on the destination decompressed matrix and a decompressed matrix corresponding to a convolution kernel to obtain a convolution operation result for the original feature map.

9. The convolution operation apparatus of claim 8, wherein the convolution operation apparatus is further configured to:
tile the original feature map to obtain at least one feature tile; and
write each feature tile sequentially to the memory according to the way of data arrangement, to obtain the memory layout;
wherein, an arrangement dimension of the way of data arrangement comprises at least a batch processing dimension, a channel dimension and a position dimension of each feature tile in the original feature map.

10. The convolution operation apparatus of claim 9, wherein the convolution operation apparatus is further configured to write at least one feature tile of a same target position in the original feature map into the memory sequentially along a direction which corresponds to the channel dimension in order to obtain a feature tile brick corresponding to the target position.

11. The convolution operation apparatus of claim 9, wherein the convolution operation apparatus is further configured to:
obtain a tile sample plate which is used to tile the original feature map;
determine a size of the tile sample plate in at least one direction;
perform zero padding on the original feature map to enable a size of the zero-padded feature map in a direction to be a multiple of a size of the tile sample plate in the direction; and
tile the zero-padded feature map according to the tile sample plate to obtain the at least one feature tile.

12. The convolution operation apparatus of claim 8, wherein there exist, in the memory layout, tile index coordinates corresponding to each feature tile; and
wherein the loading module is configured to:
obtain decompressed matrix position coordinates corresponding to any one of the sub-feature maps; wherein the decompressed matrix position coordinates are used to represent a position information of the destination decompressed matrix in a decompressed matrix corresponding to the original feature map;
map the decompressed matrix position coordinates to target tile index coordinates; wherein the target tile index coordinates are tile index coordinates, in the memory layout, corresponding to at least one target feature tile which constitutes any one of the sub-feature maps; and
load a feature tile corresponding to the target tile index coordinates in the memory layout to obtain a target feature tile.

13. The convolution operation apparatus of claim 8, wherein the decompression module is configured to: decompress the feature map which is composed of the at least one target feature tile, to obtain a decompressed matrix according to convolution parameters of a convolutional layer; and perform a transpose operation on the decompressed matrix to obtain a destination decompressed matrix.

14. The convolution operation apparatus of claim 8, wherein the convolution operation apparatus is further configured to: obtain a convolutional layer to which a current convolution operation belongs; and parse a convolution pattern of the convolutional layer to determine a convolution parameter of the convolutional layer.

15. A matrix decompression device, comprising: a tile collector, a pattern parser, a matrix processing module and a matrix buffer, wherein:
the tile collector is configured to obtain at least one target feature tile, which constitutes any one of sub-feature maps in an original feature map, from a texture unit; the at least one target feature tile is loaded by the texture unit from a preset memory layout;
the pattern parser is configured to obtain a convolution parameter of a convolutional layer;
the matrix processing module is configured to perform a decompression processing on a feature map, which is composed of the at least one target feature tile, according to the convolution parameter to obtain a destination decompressed matrix; and
the matrix buffer is configured to cache the destination decompressed matrix based on which an execute unit is able to generate a convolution operation result of the original feature map.

16. The matrix decompression device of claim 15, the matrix processing module comprises a matrix decompression engine and a matrix transpose control, wherein:
the matrix decompression engine is configured to decompress the feature map, which is composed of at least one target feature tile, according to the convolution parameter to obtain a decompressed matrix;
the matrix transpose control is configured to perform a transpose operation on the decompressed matrix to obtain the destination decompressed matrix.

17. The matrix decompression device of claim 16, wherein the convolution parameter comprises a convolution stride and a convolution kernel size; the matrix decompression engine is configured to convert, according to the convolution step size and the convolution kernel size, a feature map which is composed of the at least one feature tile into at least one row vector based on a position in the original map in sequence, and to splice the at least one row vector into a feature map matrix to obtain the decompressed matrix.

18. The matrix decompression device of claim 15, wherein the pattern parser is configured to: obtain a current convolutional layer to which a convolution operation belongs; and parse a convolution pattern of the current convolutional layer and determine a convolution parameter of the convolutional layer.

19. The matrix decompression device of claim 15, wherein the matrix buffer is further configured to transmit the destination decompressed matrix to a high-speed shared memory of the execute unit.
